(19) United States
(12) Patent Application Publication
(10) Pub. No.: US 2008/0032703 A1
(43) Pub. Date: Feb. 7, 2008

(54) LOCATION BASED NOTIFICATION SERVICES

(75) Inventors: John C. Krumm, Redmond, WA (US); Richard L. Hughes, Monroe, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/462,885

(22) Filed: Aug. 7, 2006

(51) Int. Cl. H04Q 7/20

(52) U.S. Cl. 455/456.1

(57) ABSTRACT

The subject disclosure pertains to systems and methods for facilitating provision of location based alerts or notifications to a plurality of mobile devices. An alert system can manage a set of accounts corresponding to the plurality of mobile devices. User accounts can include permissions controlling access to location information for the corresponding mobile devices. A single user can control multiple accounts by creating an independent account and one or more related dependent accounts controlled by the independent account. A user account can include a set of user-defined alerts triggered by the juxtaposition of users, geographic locations and/or events. Alerts delivered to a mobile device can include a simple text message and/or actionable data, such as location information, phone numbers and the like.

### CROSS-REFERENCE TO RELATED APPLICATIONS

This application is related to co-pending U.S. patent application Ser. No. ______, (Atty. Docket No. MS317773.01/MSFTP1471US), entitled, “LOCATION BASED NOTIFICATION SERVICES”, and filed Aug. 7, 2006.

### BACKGROUND

Mobile or portable devices have become increasingly popular and prevalent in today's society. Increased coverage areas, additional functionality and reductions in weight and size have enhanced the appeal of portable devices. Many users utilize a mobile device such as a cell phone or smartphone as their primary means of communication and carry such devices with them constantly.

One advantage of these mobile devices is their usefulness in emergency situations. For example, motorists can utilize a portable device to call or contact help when their car breaks down. Accurate location of mobile devices during emergencies can be critical. However, frequently users are not able to accurately direct emergency services to their location in such situations. Users can be flustered and signs or other location designators may not be visible during an emergency. Automatic detection of location by the mobile device can help ensure that emergency services are able to locate and assist a user in a crisis.

More and more mobile devices have begun to include automatic location detection to provide for such emergency situations. Location of mobile devices can be determined using a variety of methods, such as a Global Positioning Systems or GPS. GPS was originally a military satellite location system designed to aid the military in troop movements and equipment locations. The government has since provided tracking from their satellites to the public. The first civilian devices that utilized satellite tracking were bulky and hard to use. Since then, GPS units have shrunk tremendously in size and can be easily transported. However, by the nature of its technology, GPS works best when it can directly access a minimum number of satellites, limiting its use in congested areas such as in larger cities with skyscrapers and indoors.

In the absence of GPS, physical location of mobile devices can be determined using a variety of systems and/or methodologies, such as triangulation. Various triangulation systems can calculate the physical locations of a set of base stations based upon the strength of the signal received from the base stations as measured at multiple locations. A mobile device's location can then be determined using triangulation based upon the measurement of base station signal strengths by the mobile device. Triangulation, GPS and other location detection systems can be used separately or in combination to provide location information for mobile devices.

Availability of location information can enhance the usability of mobile devices in non-emergency situations as well. Mobile devices can include a variety functions such as cellular phone service, voice over Internet protocol (“VoIP”) phone service, software applications, email access, Internet capabilities, calendar functions, music players and the like. It is likely that functions will continue to be added to mobile devices further increasing device usefulness.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the provided subject matter concerns defining, generating and delivering alerts and/or notifications for a set of mobile devices. An alert system can be used to manage individual accounts corresponding to enrolled mobile devices. Permissions associated with accounts can be used to control access to location information for mobile devices. A single user can control multiple accounts by creating an independent account and one or more related dependent accounts controlled, at least in part, by the independent account. Each account can include a set of user-defined alerts that can be triggered or actuated based upon location related information. The alert system can provide a user interface to facilitate creation and management of both accounts and alerts.

An alert for an individual account can be defined based upon location information including, but not limited to, location of the mobile device corresponding to the account, location of other enrolled mobile devices, location of an event and combinations thereof. Such combinations provide users with tremendous flexibility in generating a variety of useful alerts. In addition, alerts can be limited or constrained to a fixed or recurring time period.

In general, triggering an alert prompts delivery of a notification such as a signal or message (e.g., a text message, graphic data, audio data, and the like). Notifications can include simple text as well as data (e.g., location information, phone numbers or coupons) that can be acted upon to retrieve additional information. For instance, a notification can include location information that can be used to retrieve a map where the location is highlighted or indicated upon the map.

In another aspect, the system can include a collection or taxonomy of predefined landmark locations to provide users with context for location information. Landmark locations can be system or user defined and are typically based upon well-known buildings (e.g., airports, stadiums, schools and the like), geographic features (e.g., lakes, rivers and parks) or other structures. Landmark locations can be provided instead of, or in addition to, traditional location descriptors, such as street address or latitude and longitude.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system for providing location based notification services for a mobile device in accordance with an aspect of the subject matter disclosed herein.

FIG. 2 illustrates a system for facilitating provision of location based notification services in accordance with an aspect of the subject matter disclosed herein.

FIG. 3 is a block diagram of a system for providing location based notification services in accordance with an aspect of the subject matter disclosed herein.

FIG. 4 illustrates a methodology for enrolling a mobile device and initializing an account in accordance with an aspect of the subject matter disclosed herein.

FIG. 5 illustrates exemplary enrollment display screens in accordance with an aspect of the subject matter disclosed herein.

FIG. 6 is a block diagram of a system for providing location based notification services for a mobile device in accordance with an aspect of the subject matter disclosed herein.

FIG. 7 illustrates a methodology for defining an alert in accordance with an aspect of the subject matter disclosed herein.

FIG. 8 is an exemplary alert definition display screen in accordance with an aspect of the subject matter disclosed herein.

FIG. 9 is a methodology for distributing notifications in accordance with an aspect of the subject matter disclosed herein.

FIG. 10 illustrates an exemplary display screen for defining an advertisement alert in accordance with an aspect of the subject matter disclosed herein.

FIG. 11 is a block diagram of a system for providing location based notification services for a mobile device in accordance with an aspect of the subject matter disclosed herein

FIG. 12 is a methodology for distributing advertising alerts in accordance with an aspect of the subject matter disclosed herein.

FIG. 13 is a schematic block diagram illustrating a suitable operating environment.

FIG. 14 is a schematic block diagram of a sample-computing environment.

### DETAILED DESCRIPTION

The various aspects of the subject matter disclosed herein are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The word “exemplary” is used herein to mean serving as an example, instance, or illustration. The subject matter disclosed herein is not limited by such examples. In addition, any aspect or design described herein as “exemplary” is not necessarily to be construed as preferred or advantageous over other aspects or designs.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

The availability of location information can enhance usability of mobile devices and provide users with information relevant to their current location. Additional functionality can be achieved if users can also receive or utilize information regarding the location of other users (e.g., family members or friends) and/or events (e.g., sales, concerts or traffic bottlenecks). In particular, alerts or notifications based at least in part upon mobile device location information can provide users with an invaluable tool for monitoring user locations, receiving information regarding local events and the like.

An alert system can provide for creation and management of user accounts corresponding to individual mobile devices. Accounts can be used to control access to location information for enrolled mobile devices and to manage a set of alerts. As used herein, an alert defines a set of conditions, which when met, result in the transmission of a message or signal to a device (e.g., cell phone, PDA, laptop computer, desktop computer). Location information can include location of the mobile device, location of other mobile devices enrolled in the alert system, location of events or activities and other any information derived from current or previous locations of users or events.

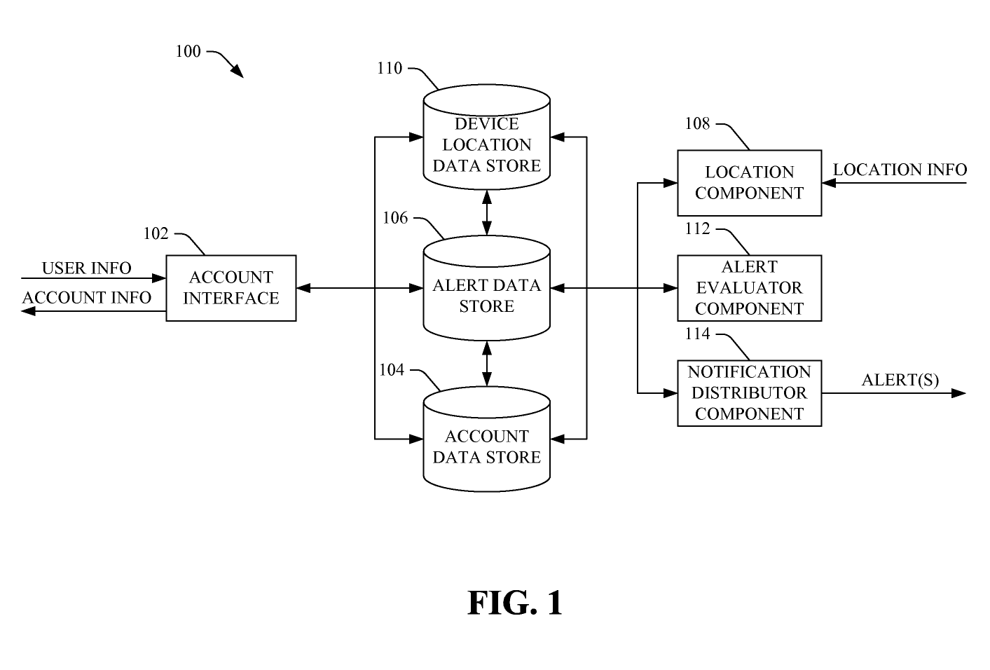

Referring now to FIG. 1, a system 100 for facilitating provision of location based alerts is illustrated. The alert system 100 can include an account interface 102 that allows users to enroll, initialize, manage and maintain user accounts. Users can provide user and mobile device information to the account interface 102 and receive account information. Accounts can be used to manage a set of alerts and to control access to location information for corresponding mobile devices. Each account can represent a separate mobile device. In general, a mobile device can be considered to be a tangible instantiation of an account. Alternatively, a single account can be used to manage multiple mobile devices. As discussed in detail below, an account can include associated alerts, information regarding account relationships and permissions controlling access to location and account information.

Information related to accounts can be stored in an account data store 104. A data store, as used herein, is any collection of data including, but not limited to, a database or collection of files. The account data store 104 can include user information (e.g., a user or account identifier and contact information), information regarding the relationship of the account to other accounts (e.g., dependencies) and any alerts associated with the account. A dependent account can be created for children or the elderly who might not be able to control their own account effectively. Alert information can be stored with account information in the account data store 104, in a separate alert data store 106, or in a combination thereof. The alert data store 106 can maintain alerts defined for accounts of the alert system. Typically, an alert is associated with a particular user account.

The alert system 100 can include a location component 108 that can receive, obtain or retrieve location information for a set of mobile devices. The location component 108 can receive location information periodically and/or dynamically. Alternatively, the location component 108 can request and/or retrieve information either periodically or dynamically. The location information can include any data indicative of the current location of a mobile device including, but not limited to, latitude and longitude, street addresses or any other geographic designators. Additionally, location information can include any information from which location of a mobile device can be deduced or estimated. For instance, the location information can include signal data from which the position of the mobile device can be computed using triangulation algorithms.

Location information for enrolled mobile devices can be maintained in a device location data store 1 10. Alternatively, location information for each mobile device can be stored with account information for the mobile device and maintained in the account data store 104. The device location data store 110 (or account data store 104) can maintain a history of previous location information for the mobile devices. The location information can include a timestamp indicating the time at which the location information was generated or recorded.

The alert system 100 can also include an alert evaluator component 112 that can determine when alert conditions have been met, triggering distribution of one or more notifications. The alert evaluator component 112 can periodically determine whether any alerts in the system 100 have been actuated based upon the most recent location information and alert conditions. Alternatively, the alert evaluator component 112 can dynamically review a subset of available alerts based upon received location information. For instance, if updated location information is received for a particular mobile device, the alert evaluator component 112 can review only those alerts defined based upon the position of the particular mobile device, and generate any notifications based upon the updated location information.

When the alert evaluator component 112 determines that an alert has been actuated, a notification can be distributed to appropriate mobile devices by a notification distributor component 114. A notification distributor component 114 can transmit generated notifications periodically or dynamically. Alternatively, the notification distributor component 114 can provide notifications to mobile devices upon receiving a request from the mobile devices or account. For instance, if a mobile device has been turned off or has left the coverage area and is unable to connect to the system 100, the mobile device can request the most recent notifications upon resuming contact with the system 100. In addition to automatically generated notifications, an account can request and receive location information for any mobile device enrolled in the system 100, if the account has the correct permissions. The permissions required to access and utilize location information for mobile devices are discussed in detail below. The notification distributor component 114 can also ensure that relevant data is included in the notification and that notifications are formatted for individual mobile devices. For instance, a notification can be sent as an SMS message to a cell phone or as an email message to a laptop with Wi-Fi access.

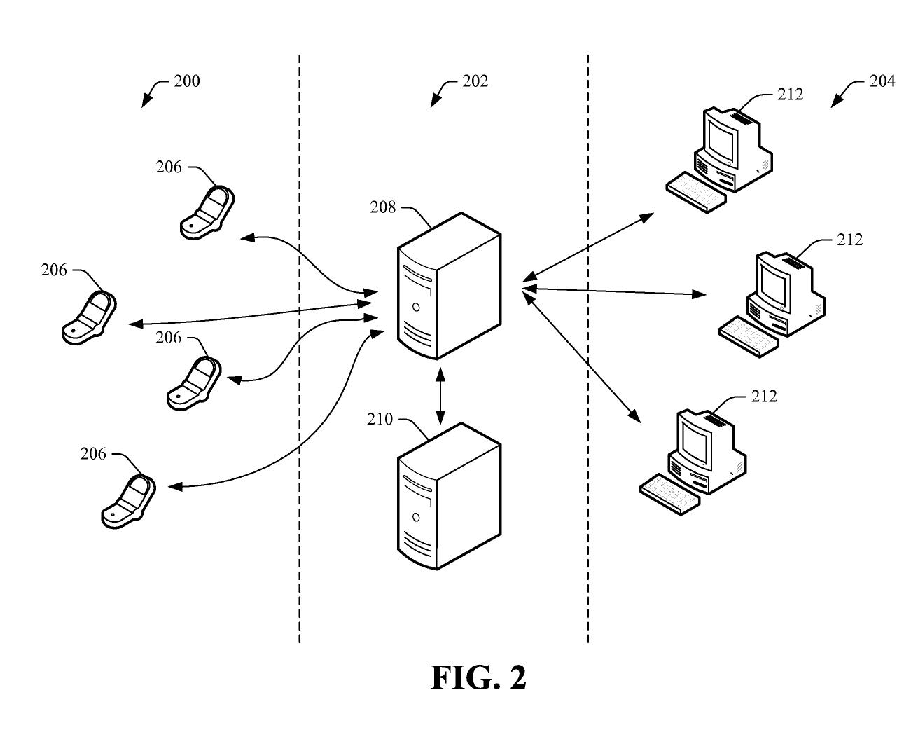

Referring now to FIG. 2, an exemplary system for facilitating provision of location based notifications is illustrated. The system can include a set of mobile devices 200, an alert system 202 that manages alerts for the set of mobile devices and a set of terminals 204 that can connect to the alert system 202 to create and manage accounts and alerts associated with the set of mobile devices 200. The set of mobile devices 200 can include any number of mobile devices 206. Mobile devices 206 can include laptops, personal digital assistants (PDAs), cell phones, smartphones, devices with Wi-Fi and the like. Location information for the mobile devices 206 can be provided to the alert system 202.

The alert system 202 can include a network server 208 (e.g., a HTTP server) and a data store server 210 (e.g., a database server). The data store server 210 can manage and support location, account and alert information. The network server 208 can allow users to access account information maintained in the data store server 210. Although a single network server 208 and data store server 210 are illustrated, the alert system 202 can include any number of network servers 208 and data store servers 210. Alternatively, location, account and alert information can be stored as a set of files shared over a network using a peer-to-peer (P2P) file distribution application. Relevant account and alert information can be located on a set of mobile devices and shared as needed.

The set of terminals 204 can connect to the network server 208 via a network (e.g., the Internet). The set of terminals 204 can include any number of terminals 212. Terminals can include desktop computers, laptops, PDAs and the like. Users can utilize terminals 212 to create and/or manage mobile device accounts. Accounts can also be managed from mobile devices 206. However, in general, mobile devices include limited user interfaces (e.g., display screens and keypads) to minimize size and weight of such devices and enhance portability. Accounts can be managed using terminals 212 to provide users with enhanced user interfaces and facilitate management of accounts and alerts.

The mobile devices 206 can be enrolled and associated with an account of the alert system 202. Location information for each enrolled mobile device should be provided to the alert system 202 and can be used to trigger alerts prompting distribution of notifications. Location information can include geographic designators such as latitude and longitude, street address and the like. Additionally, location information can include information from which location can be computed or estimated. Location can be determined either at the mobile device, at the alert system 202 or at a separate system (not shown). The location information can be provided periodically or dynamically to the alert system 202.

Location of the mobile devices 206 can be determined in any manner that allows location information to be provided to the alert system 202. For example, location can be determined using a GPS associated with the mobile device. Alternatively, any or all of a variety of triangulation algorithms can be used to calculate mobile device location based upon signals received at the mobile device and position of base stations and transmitters.

Users can also elect to self-report or assert the current location of a mobile device. Users can advise the alert system 202 of the location of the mobile device 206 either by inputting a geographic designator or entering or selecting from a provided set of predefined locations. The system can include a set of predefined locations and users can add user-specific locations, such as the user's home, work or school locations. The user can also elect to share their list of custom defined locations with other users (e.g., family or friends). Locations can be defined either through the set of terminals 204 or the set of mobile devices 200. To report current location, a user can select a current location from a list of predefined locations displayed on a mobile device 206.

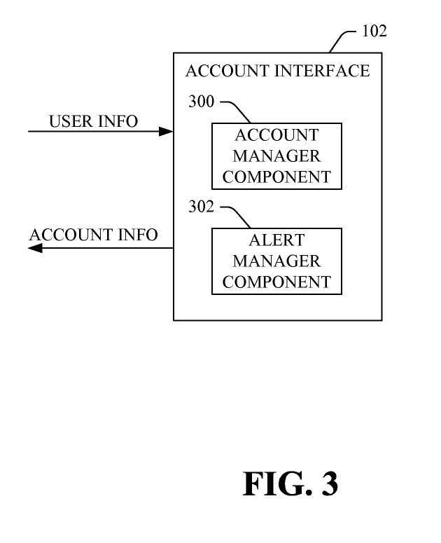

Referring now to FIG. 3, a detailed diagram of an account interface 102 is illustrated. The account interface 102 can provide a graphical user interface (GUI) that allows users to enroll and initialize an account, modify an account, and manage alerts associated with the accounts. The account interface 102 can include an account manager component 300 that provides mobile device users with the ability to enroll and manage accounts and permissions. Prior to receiving notifications from the alert system, users can enroll their mobile devices, setting up permissions regarding access to location information. The alert manager component 302 allows users to define and manage alerts associated with an account and ensure that the mobile device user has the requisite permissions to create the alerts. Creation of an alert will be discussed in detail below.

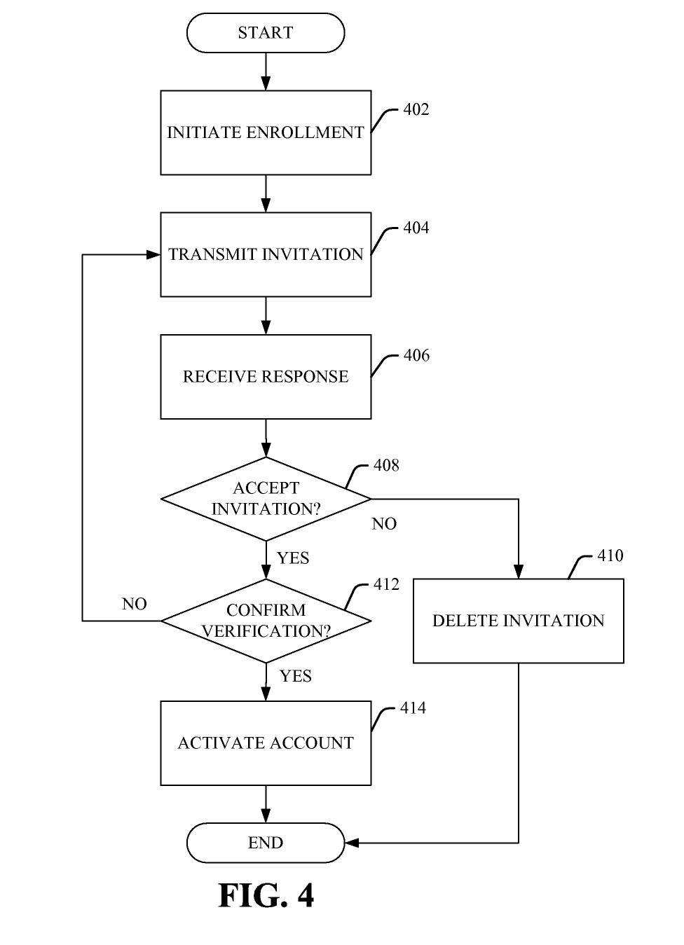

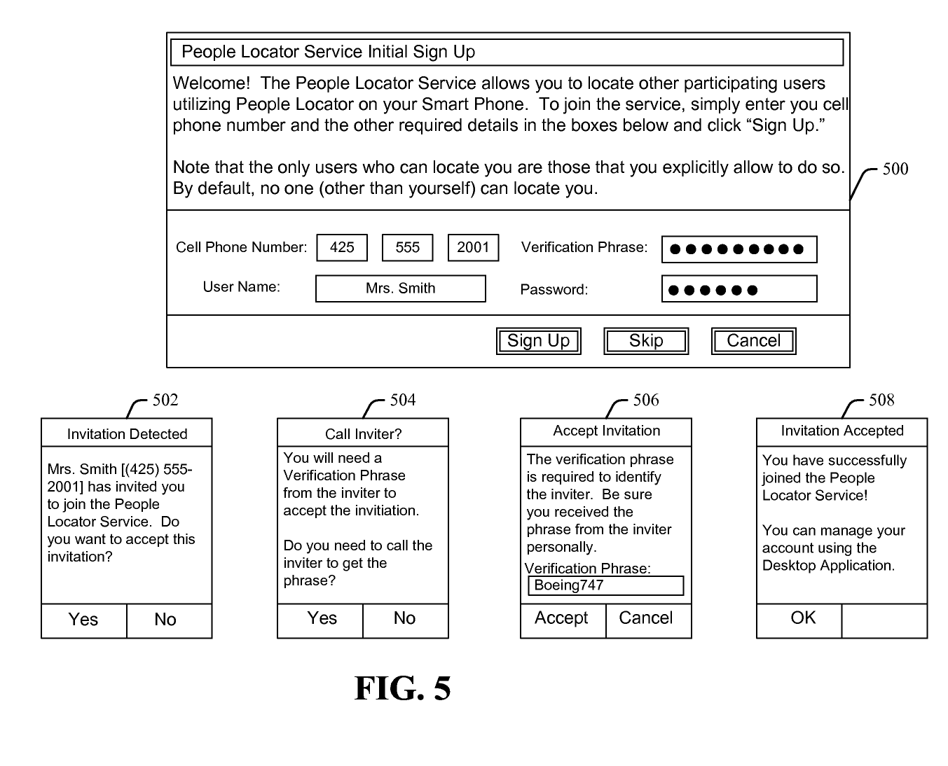

Referring now to FIGS. 4 and 5, FIG. 4 illustrates a methodology for enrolling a mobile device and initializing an account. FIG. 5 illustrates exemplary display screens for the enrollment process. The enrollment process can utilize both a terminal and the mobile device to ensure security and facilitate account configuration. At reference numeral 402, the enrollment process can be initiated. Enrollment of a mobile device can be initiated through a network, such as the Internet, via a terminal, such as a desktop computer. Enrollment and account management through a terminal allows users to view account details. A single user can utilize a terminal and mobile device together to initialize the mobile device account. Alternatively, a user at a terminal can extend an invitation to a mobile device user to create an account.

During account initialization, the owner or user of the mobile device can be prompted to enter information necessary to establish an account. For example, the user can be prompted for information required to contact the mobile device (e.g., cell phone number), a user or account name associated with the account, a password to be used to access the account in the future and a verification phrase. The verification phrase can be used to help ensure the person initiating the account has the authority to enroll the mobile device and create the corresponding account.

At reference numeral 404, an invitation to confirm enrollment in the alert service is transmitted to the mobile device whose identifier was entered during account initialization. The invitation notifies the individual in possession of the mobile device of account initialization and requests that the individual confirm creation of the account. At reference numeral 406, a response to the invitation is received. A determination is made as to whether the invitation is accepted at reference numeral 408. If the invitation is declined, the invitation is deleted at reference numeral 410 and the process terminates. If the individual desires to create the account, the response includes the verification phrase to confirm the account. Inclusion of the verification phrase ensures that the individual initializing the account and the individual in possession of the mobile device are either one and the same or that the individuals have agreed upon a verification phrase and creation of the account.

At reference numeral 412, a determination is made as to whether the received response includes a verification phrase identical to the verification phrase established during initialization. If yes, the account is created and activated at reference numeral 414 and the enrollment process terminates. The newly created account can be accessed using the password established at initialization. If the verification phrases are not identical, the process can return to reference numeral 404, and generate another invitation requesting that the individual reenter the verification phrase. If the verification phrase is incorrectly entered multiple times, the process may terminate.

Referring now to FIG. 5, an exemplary initialization screen 500 can be provided to allow a user to enroll a mobile device and initialize an account. The initialization screen 500 can be accessed using a desktop computer. The initialization display screen 500 includes fields prompting a user to enter initialization information. The user who begins the initialization process is referred to herein as the inviter. Here, initialization information includes the cell phone number, the user name, a verification phrase and a password. After entering the initialization information, the inviter can begin the initialization process and an invitation can be sent to the associated cell phone.

An exemplary invitation display screen 502 illustrates the invitation received at the cell phone. The invitation advises the cell phone user that the initialization process is underway and allows the cell phone user to indicate whether they wish to continue with the initialization process. Confirmation by the cell phone user prevents individuals from setting up accounts for mobile devices belonging to others without permission. If the cell phone user wishes to continue initialization of the alert server account, a confirmation display screen 504 can be displayed allowing the cell phone user to elect to contact (e.g., via a phone call) the inviter to get the verification phrase. The cell phone user can call the inviter to obtain the verification phrase without disrupting the initialization process. By obtaining the verification phrase directly from the inviter, the cell phone user confirms the identity of the inviter. The cell phone owner can initialize their own account, in which case the inviter and the cell phone user would be the same individual.

Once the cell phone user has received the verification phrase, an exemplary verification display screen 506 can be rendered including a prompt to enter the verification phrase. Once the verification phrase is correctly entered, a successful initialization display screen 508 can be rendered indicating that the account initialization process has been successfully completed. The account can be further configured using a terminal or desktop to facilitate account setup.

The system can provide multiple types of accounts, such as independent accounts and dependent accounts. Typically, each mobile device can be connected to a single account. However, a single user can control multiple accounts by creating an independent account and one or more related dependent accounts governed, at least in part, by the independent account. All accounts can include a set of permissions controlling access to location information for the corresponding mobile device. In particular, each account can include a list of locate permissions and a list of alert permissions. A locate permission gives the account the ability to access location information for a mobile device associated with another account. This gives the account the ability to locate the mobile device. An alert permission gives the account the ability to define an alert based upon the location of a mobile device associated with another account. In addition, each account can track the permissions that it has granted to other accounts, allowing other accounts to locate or define an alert based upon the location of the mobile device associated with the account. Additional permissions can include defining locations and/or regions, creating or modifying alerts associated with an account, controlling subordinate or dependent accounts and unsubscribing from the alert system.

Independent accounts can control the grant of permissions associated with the account. In contrast, dependent accounts can have limited control of account permissions. Each dependent account can be related to, or dependent upon an independent account. The independent account can determine the specific permissions available for any dependent account. Dependent accounts can be useful in situations where individuals should not have control of the full features of the alert service. For example, a parent may set up a dependent account for their child or an adult child may set up a dependent account for their elderly parent.

During account initialization or configuration, each independent account can grant locate, alert or any other permissions to other accounts. Dependent accounts can grant permissions as allowed by the independent account governing the dependent account. Grants of locate, alert and other permissions are distinct from the independent/dependent account relationship. For example, when a first account grants locate and/or alert permission to a second account, the first account retains control and can cancel either or both permissions at any point. In contrast, dependent accounts may control only a subset of their permissions. Instead, the permissions of dependent accounts can be governed by related independent accounts.

The user can manually grant account permissions at any time utilizing the account interface if the user's account permits it. Alternatively, the alert system can be utilized in conjunction with a social network to automatically generate default grants of permission. Permissions can be added, cancelled or modified at any time. For example, a user may wish to initialize his account by allowing all friends in his social network to set alerts based upon his location. As additional friends are made, the user can add those new friends (if they enroll in the alert system) to his permissions. Similarly, the user can remove individual accounts from his permissions or modify the granted permissions.

The account interface can provide a set of templates to facilitate the granting of common types of permissions. For example, if the user identifies another account as a family member, the family member account can automatically be granted both locate and alert permissions. In addition, users can generate custom templates to meet the user's specific needs. For example, an employer can generate a template to be used by their employees that grants locate permission to the employer only within regular business hours.

The scope of permission grants can be limited to increase flexibility and usability. A user can grant locate permission for a limited period of time, or for certain recurring periods of time. For example, an employee may grant locate permission to an employer or coworker limited to between the hours of nine o'clock and 5 o'clock on weekdays. Outside of work hours, the employer should not have permission to locate the employee. Alternatively, the scope of permissions can be limited geographically. For instance, a user may allow coworkers to determine when he is within the office or to locate him within a warehouse or on the company campus, but not once he has left a predefined geographic area, such as the company grounds.

Alert conditions can be based upon the juxtaposition or proximity of a first entity with a second entity, where an entity can be an individual mobile device, a geographic region, a geographic location or an event. Typically, it is the combination of two or more entities or features that triggers distribution of a notification to a mobile device. For example, an alert can be defined so that a notification is distributed when a first entity is in close, physical proximity to a second entity. Users can define alerts through a GUI accessible through a terminal or through the mobile device.

Alerts are frequently defined based upon location of a specific mobile device and consequently, the location of the user of the mobile device. For simplicity, it is assumed herein that location of a mobile device corresponds to the location of the person using the mobile device. Alert conditions can be based upon location of the mobile device corresponding to the account for which the alert is defined. For instance, a user can define an alert based upon their current location. Users can also define alerts based upon the location of any other mobile device enrolled within the alert system and for which the user has alert permission. A user can define a position update alert that notifies the user of the current location of a target mobile device (and its owner) on a periodic basis. For example, a parent can generate an alert that notifies the parent of their child's location every thirty minutes. Users can also dynamically request the current location for any mobile devices enrolled within the alert system for which the user has locate permission. For instance, a parent can request the current position of their child at any time, if the parent has locate permission for the child's mobile device.

An alert can also be defined based upon a person's amount of motion during a period of time, instead of, or in addition to their specific geographic position. An alert can be actuated and a notification distributed based upon excessive distances traveled during a given time frame. This type of alert can be used to determine if a teenager is cruising, or driving up and down the same strip of road. While the teenager may not travel far from home, location information from the teenager's mobile device can be used to determine that the teen has traveled an inordinate distance. For instance, an alert can be actuated if the teenager travels more than sixty miles on a Friday night. Conversely, an alert can be actuated based upon lack of motion. For instance, a notification can be generated to notify an adult child if their elderly parent has not moved for an eight-hour period during the day.

Alerts can also be defined to notify a user if location information becomes unavailable for an individual mobile device for a period of time. For instance, an alert can be triggered if location information has not been updated for more than two hours. Stale or out of date location information can indicate that the individual has turned off the mobile device, that there is a problem with the mobile device or that they have left the coverage area for the system.

Alerts can be defined based upon the proximity of enrolled users to one another. A user may wish to be notified any time a particular friend is within their proximity. For example, an alert can be specified to notify the user if the friend is within 0.1 miles of the user's current location. Conversely, the user can define an alert that is actuated when an individual is no longer in physical proximity of the user. For example, during a family trip to an amusement park, a parent may wish to set an alert that would be triggered if their child were more than 0.1 miles from the current location of the parent.

The user can also define groups or categories of people (e.g., family, friends and coworkers) that can be shared with other users. These categories can be used during alert definition, allowing the user to receive a notification if any of their friends is within 0.1 miles of their current location. The user can also set an alert triggered if any person for whom the user has alert permission, regardless of category, is in proximity to the user.

Alert conditions can also be based upon the proximity of multiple, mobile device users to each other. An alert can be defined to actuate whenever two or more enrolled mobile device users, for whom the user has alert permission, are within 0.1 miles of each other. For instance, an employee could set an alert that would notify him whenever two or more members of his work group are in close physical proximity to each other, possibly indicating a project meeting. Similarly, the user can create an alert actuated when any three or more coworkers are in physical proximity to each other. Conversely, the user can also define an alert triggered when two enrolled individuals are separated by more than a predefined distance. For instance, one parent can define an alert that is triggered when the other parent is separated from a child by more than 0.1 miles.

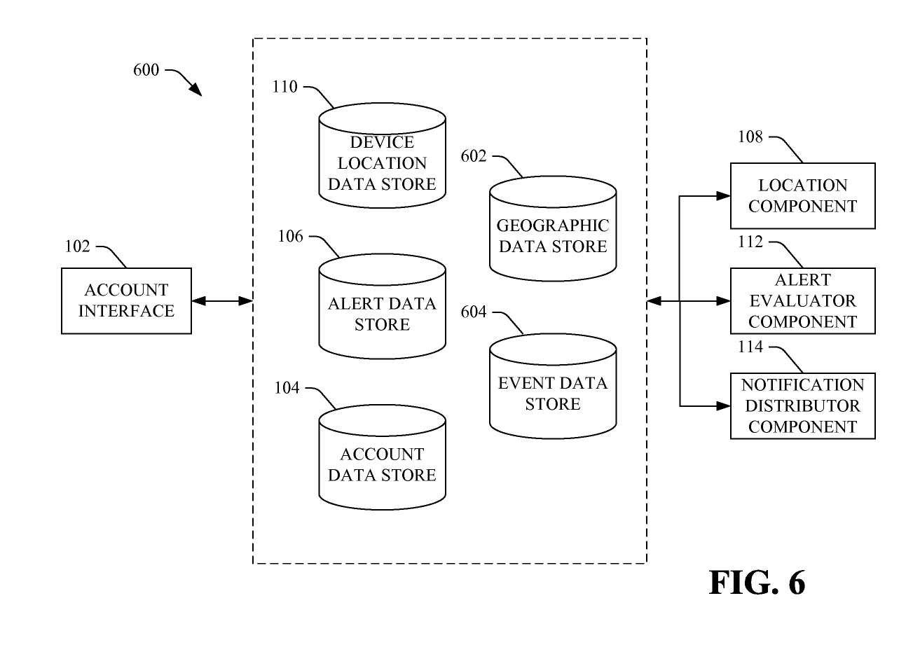

Referring now to FIG. 6, an exemplary alert system 600 is illustrated. The alert system 600 can include a geographic data store 602 and an event data store 604 used in the generation and management of alerts. Alerts can be defined based upon the juxtaposition of entities including geographic locations and events as well as to individuals. The geographic data store 602 and the event data store 604 can include categories and specific instances of geographic locations and events, respectively.

Geographic locations can include specific locations or points of interest (POIs). The alert system 600 and particularly the geographic data store 602 can include a set of predefined locations, such as airports, historical monuments (e.g., the Lincoln Memorial or the Statue of Liberty), universities (e.g., The Ohio State University), hospitals (e.g., The Cleveland Clinic) and the like. Users can also define additional, customized geographic locations. For example, a user can define his or her home, business office and the like. Users can also elect to share lists of POIs with other users. For instance, a family may share a list of POIs including the family home, the children's schools and the like. In addition, users can generate and share lists with other, non-related users. A user with an interest in fishing can generate POIs indicating favored fishing spots and make the list available to other fishermen.

Alerts can be defined based upon the combination of one or more people and a location or POI. For example, an alert can be defined that notifies a parent when a child arrives at home each day. Conversely, an alert can be defined that notifies a parent when a child leaves the family home.

POIs can be grouped based upon predefined categories to facilitate alert generation and management. Exemplary categories include historical monuments, hospitals and airports. Users can also define and share POI categories of particular interest to the individual user (e.g., flea markets and free parking lots). Users can generate alerts that are triggered when the user is within a predefined distance of an instance of a POI of a selected category. For example, a user can elect to be notified whenever they are within 0.5 miles of a hardware store. Users can also define alerts based upon the proximity of third parties to an instance of POI of a selected category. For instance, a user may wish to be notified whenever their grandmother is within 0.1 miles of any hospital.

Geographic locations can also be defined based upon regions or geographic areas. As used herein, a geographic region is a physical area with defined boundaries. The alert system 600 can provide predefined regions, such as states, counties or amusement parks. Users can also create and share customized regions. Regions can be defined using a graphic interface to outline areas on a provided map. Regions can also be defined as a circular area based upon selection of a center geographic point and a radius from that point. Furthermore, a region can include a route, such as the user's regular commute. Defined geographic regions can be used to generate alerts in the same manner as POIs. For instance, a user can outline a particular neighborhood on the map and define an alert that notifies the user if their child leaves the neighborhood. A user wishing to pick their spouse up at the airport can generate an alert that is actuated once the spouse arrives in the region for the airport.

As illustrated in the preceding examples, the combination of people and geographic locations (including regions and POIs) can be used to generate a variety of useful types of alerts. As described above, notifications can be distributed when the user or a third party is in proximity to or within a geographic location. Conversely, an alert can be defined to notify the user when the user or a third party is not proximate to or within the geographic location. For example, a parent can be notified when their child leaves their school region.

Time constraints can also be utilized to further enhance the utility of alerts. Alerts can be actuated if an individual remains proximate to a geographic location for longer than a specified period of time. For example, a parent may wish to receive a notification if a child has remained within an arcade for over two hours. Alternatively, an alert can be actuated if an individual is not proximate to a geographic location for longer than a specified period of time.

Alerts can also be defined based upon geographic locations and groups or categories of people. Alerts conditions can be defined to trigger distribution of a notification when any or all of a group of locatable persons are in a region. A user can define an alert actuated when any one friend of the user is in the mall or when any combination of friends is in the mall. An alert can also be generated when no locatable persons are within a region. For example, the user may wish to be notified when none of his or her family members are at home.

Events or activities can also be used to trigger alerts. Instances of events can be provided by the alert system or can be defined by individual users. Predefined categories of events can be provided by the system or created and shared by users. Event categories can include concerts, sales, traffic jams, garage sales, parades, or any other type of activity or occurrence that can be of interest to users. Events and event categories can be maintained in the event data store 604 and used to define a variety of alerts. Event information maintained in the event data store 604 can include a description of the event, an event category for the event, a location and a time or time frame for the event. Alerts can be defined based upon events or categories of events in proximity to or within geographic locations, such as regions. For example, a user can define an alert triggered by a concert event currently taking place within the downtown region.

Events can be created and shared by the system operators, businesses and by individual users. Users can create and share events with a subset of system enrollees, (e.g., family members only) or with the general public. For instance, a user can create a public garage sale event scheduled for Saturday morning at a specific address. Unrelated users can receive alerts regarding the garage sale, if they have created alerts conditioned upon garage sale events within a region that includes the garage sale address. This event sharing capability can be used to create a virtual community bulletin board, where individuals can create events and post events. Users can define alerts to filter events and receive notifications for only those events most likely to be of interest to the individual user.

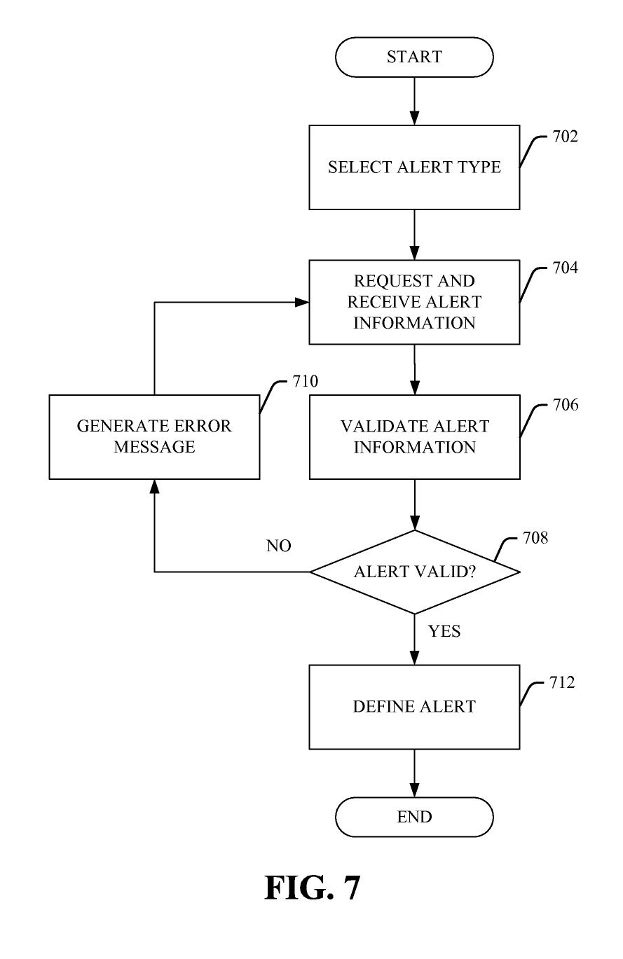

Referring now to FIG. 7, a methodology for defining an alert is illustrated. At reference numeral 702, the type of alert to be created is selected. To facilitate alert creation, a user interface can provide users with a set of templates for generating valid alert types. Upon selection of a type of alert, the user interface can be populated and the user prompted for information required to define the alert at reference numeral 704. Such information can include the persons, geographic locations, events and time constraints for the alert. User can also be prompted to enter information regarding the mobile device or method by which the alert is to be provided. For example, the user can provide the address of the device to which the alert is to be delivered. The user can also be prompted to provide time constraint information describing the period of time for which the alert should remain active. Alerts can be active for set periods of time or can be active during recurring periods of time.

At reference numeral 706, the information can be validated to ensure that the account has the permissions required to define the alert. In addition, information such as start time and end time can be verified to ensure that a valid alert is defined. At reference numeral 708, a determination can be made as to whether the entered information is valid. If no, an error message can be displayed at reference numeral 710, and the process can return to prompt the user for correct information at reference numeral 704. If the information is valid, at reference numeral 712, an alert is defined.

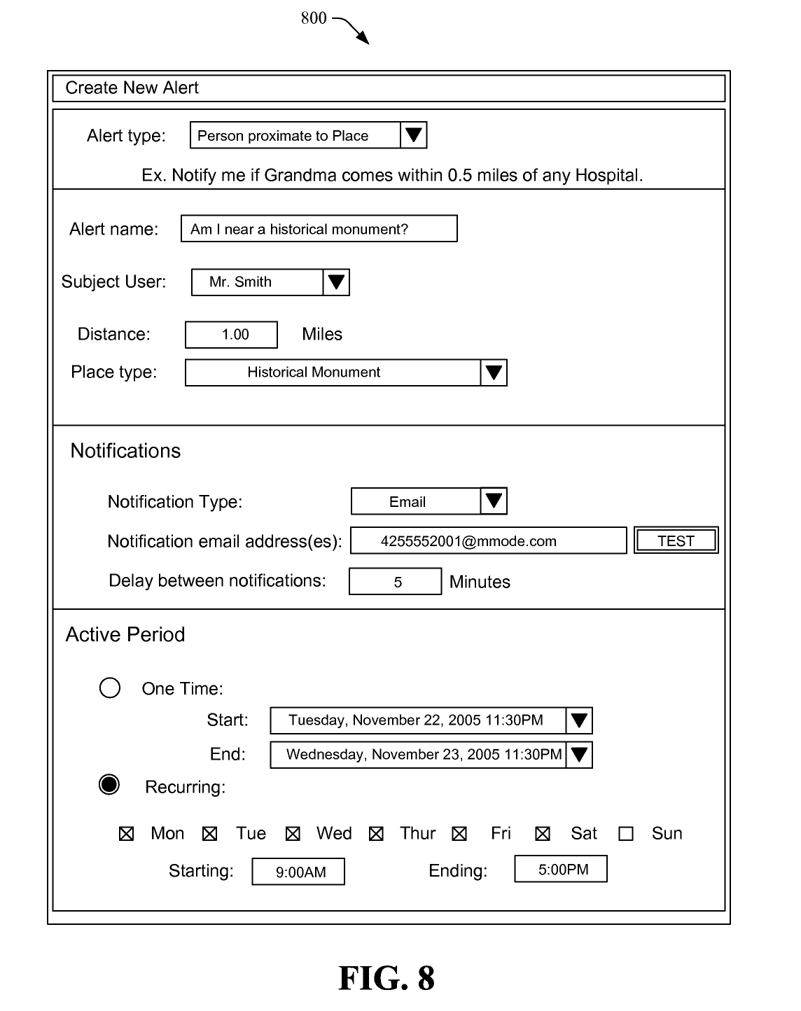

FIG. 8 is an exemplary display screen 800 for defining an alert. Here, a user has elected to create an alert defined by proximity of a person to a particular type of place. Based upon the type of alert the user has elected to create, the display screen prompts the user to provide the necessary information to generate the alert. As shown here, the user can provide a name for the alert, allowing the user to manage and distinguish among multiple alerts. For an alert conditioned upon proximity of a person to a particular category or type of place, the user is prompted to identify the person, the type of place and enter a distance that determines proximity to the place. The user can also enter notification information, such as the type of notification (e.g., email, voicemail, SMS text message and the like), address or identifier at which a user or users to be notified (e.g., email address) and a delay between repeated notifications. Users can also define a time frame or period during which the alert will be active. Alerts can be active for a specific, set period of time or for recurring time periods (e.g., nine o'clock to five o'clock on weekdays). Unavailable options can be grayed out on the display screen, preventing the user from entering inconsistent information.

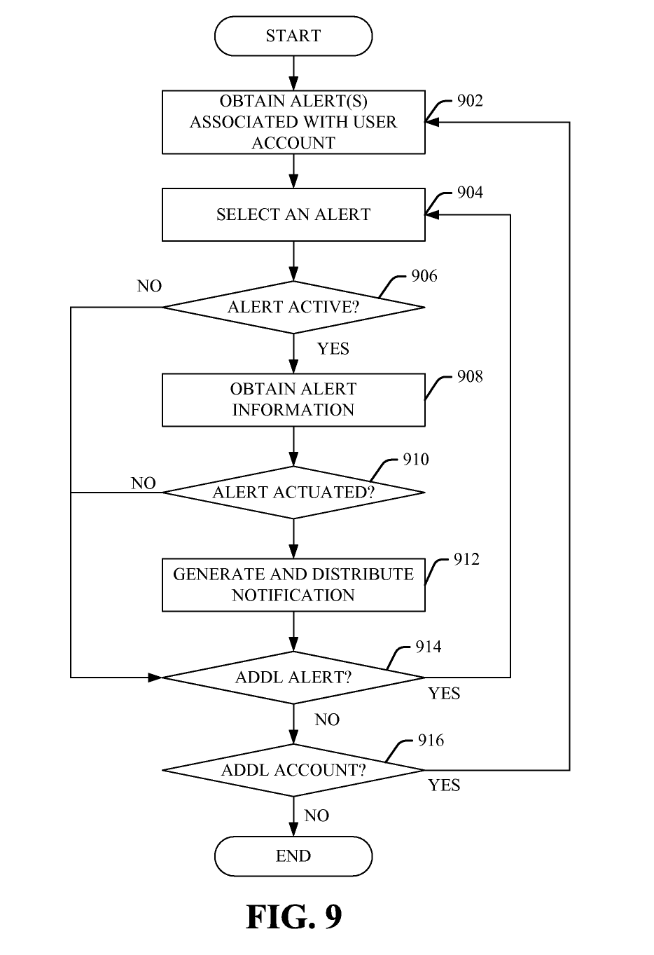

Referring now to FIG. 9, a methodology for distributing notifications is illustrated. At reference numeral 902, one or more alerts associated with an account can be obtained. At reference numeral 904, one of the alerts associated with the account is selected. A determination is made as to whether the alert associated with the account is active at reference numeral 906. If the alert is not active, the process proceeds to reference numeral 914 where it is determined if there is another alert. If yes, the process returns to reference numeral 904 and another alert is selected. If there are no additional alerts, a determination is made as to whether there are additional accounts to be processed at reference numeral 916. If there are additional accounts, the process returns to reference numeral 902. If there are no additional accounts, the process terminates.

If it has been determined that the alert is active at reference numeral 906, alert information is obtained at reference numeral 908. Based upon the obtained information, a determination is made as to whether the alert has been actuated at reference numeral 910. If no, the process proceeds to reference numeral 914 where it is determined if there is another alert. If yes, the process returns to reference numeral 904 and another alert is selected. If there are no additional alerts, a determination is made as to whether there are additional accounts to be processed at reference numeral 916. If there are additional accounts, the process returns to reference numeral 902. If there are no additional accounts, the process terminates.

If it has been determined that the alert has been actuated at reference numeral 910, a notification is generated and distributed to the appropriate mobile device at reference numeral 912. At reference numeral 914, a determination is made as to whether there are additional alerts to be processed. If yes, the process returns to reference numeral 904 and the next alert is selected. If no, at reference numeral 916 a determination is made as to whether there are additional accounts to process. If yes, the process returns to reference numeral 902 and the next user account is processed. If no, the process terminates.

Notifications can be distributed or delivered to the mobile devices in a variety of forms. A notification can be a simple short message service (SMS) text message delivered to a cell phone. In addition to simple text, a notification can include geographic location information, phone numbers or even an electronic coupon. The alert system can generate a temporary geographic location based upon the alert. For example, if an alert is triggered by an event within a geographic region, the notification received at a mobile device can include not only text describing the location, but location information (e.g., a street address or latitude and longitude) that can be used to retrieve additional information about the location of the event. The user may be able to retrieve a map with the event location highlighted or indicated upon the map. The user can act upon the provided location information rather than simply receiving passive text. The notification can also contain a phone number associated with the alert. For example, the phone number of the user whose location is monitored or a phone number associated with the event can be provided within the notification. By simply selecting the phone number, the user can contact the event and receive additional information.

Alerts can also be used in an advertising context. Typically, notifications generated by advertisement alerts are distributed as mobile devices approach a location, generally the location of the vendor. The account interface can allow users to specify the types or categories of advertisements that the users would be interested in receiving. Users can define alerts that allow them to receive specific types of advertisements. Allowing users to select categories of offers increases the likelihood that the user will be interested in the goods or services advertised. This increases both the utility of advertisement to users and the effectiveness of the advertisement for the vendor.

Advertisement notifications can be used to defer the cost of maintaining an alert system. In one case, the system can automatically send advertisements to users based upon the conditions of the advertisement alert and without allowing users to opt out of receiving the advertisement. In this case, the alert system may be provided to users without charge. The system provider can receive fees from vendors in return for distributing advertisements. The total number and/or type of advertisement notifications a user receives can be limited to avoid excessive distractions. Alternatively, users can pay a subscription fee to the system provider. In return for the fee, the user can receive advertisements only if the user explicitly requests such advertisement notifications.

In yet another alternative, a hybrid of the preceding models can be employed. The system can include multiple levels of service. The alert system may be available without charge, if the user is willing to accept a significant number of advertisements. The users may be able to specify particular types of advertisements that they wish to receive. However, the user can reduce the number or type of advertisement notifications received in exchange for paying a small fee or premium. Any number of levels of service can be defined with varying fees based upon the number or type of advertisements the user is willing to receive.

Users can also elect to subscribe to certain types of location-based alerts provided by third parties. Certain alert types can be so useful that users may be prepared to pay a premium or a subscription fee for the service. For example, a third party can compile information such as traffic updates, speed trap information, nearby entertainment events, restaurant information or tourist information. Users can subscribe to these third party services and the alert system can receive a portion of the subscription fees in exchange for distributing the associated notifications.

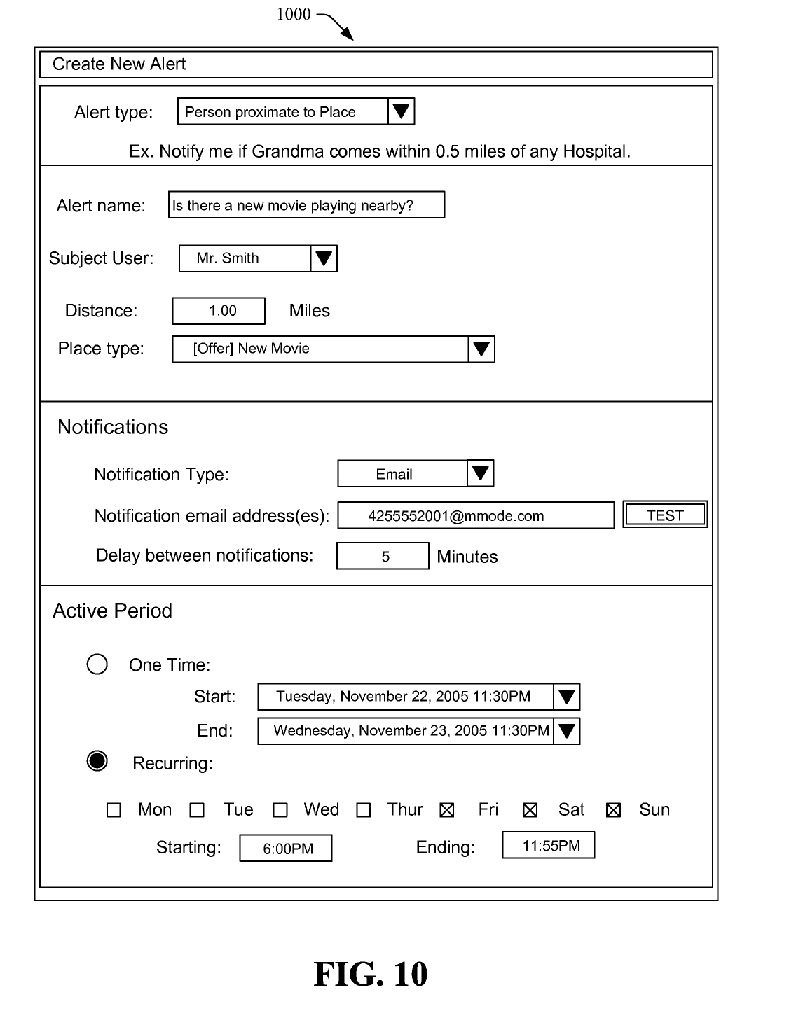

Referring now to FIG. 10, an exemplary display screen for defining an advertisement alert is illustrated. Here, the user is creating an alert conditioned upon the user's proximity to a place type. However, the place type selected is an offer or advertisement for a newly released movie. The user has limited the active period of the alert to Friday, Saturday and Sunday evenings. Consequently, if the user is within a predefined distance (e.g., 1.0 miles) of a location that is distributing an offer or advertisement for a newly released movie during the active period of the alert, the user will receive a notification including location information associated with the offer.

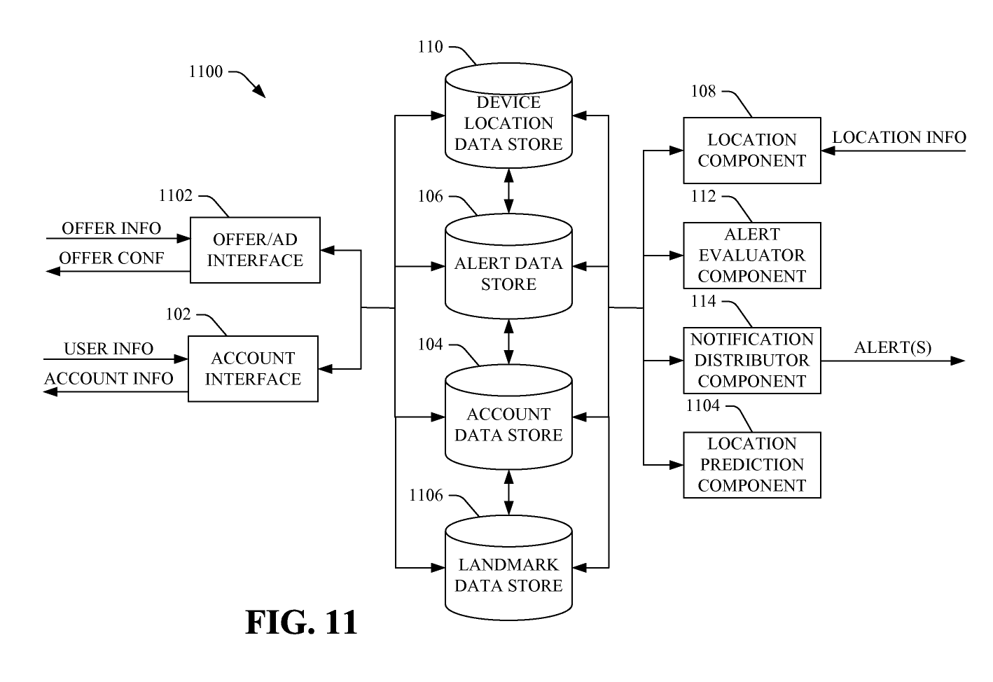

Referring now to FIG. 11, an alert system 1100 is illustrated that allows vendors to purchase advertisements. The alert system 1100 can include an offer or advertisement interface 1102 that allows vendors to define and purchase advertisement alerts. Vendors can specify text to be included in the advertisement notification, a geographic location or region associated with the advertisement alert and a category or classification for the advertisement alert. Categories can describe the goods or services offered by the vendor. For example, movie theater advertisements can be classified as entertainment, or more specifically as movies, while an advertisement alert for a restaurant can be classified as dining. The system 1100 can include a hierarchical set of categories. Categories can be further divided into subcategories (e.g., dining can include subcategories such as fast food and fine dining). Vendors can select a category and/or the alert system can categorize an advertisement alert based upon products and services offered. Vendors can also specify limited time periods during which the advertisements are to be distributed. For example, restaurants can issue advertisements just prior to the dinner hour.

The alert system operator can sell exclusive advertisement rights for a particular advertisement category to vendors for defined regions or specified periods of time. For example, a restaurant owner can purchase the exclusive rights for food advertisements within two blocks of the restaurant during the lunch hours. Alternatively, the owner of a first restaurant can purchase the exclusive advertisement alert rights for a region proximate to a competing restaurant. The system operator can auction off advertisement rights, requiring vendors to bid for particularly popular advertising categories, regions or times.

The advertisement interface 1102 can also allow vendors to specify a limited quantity of advertisement notifications to distribute. Vendors may be charged based upon the number of users that receive the advertisements. To limit expenditures, vendors may elect to distribute advertisements to a predetermined number of users. In addition, due to the short period of time required between purchase and distribution of advertisements, vendors can monitor the effectiveness of the advertisements and purchase additional advertisements as needed.

The time and location sensitive nature of advertisements distributed through the alert system 1100 provides increased flexibility for vendors. For example, a particular restaurant may be having a slow lunch crowd. The owner of the restaurant can contact the alert system 1100 and purchase a specific number of advertisements (e.g., fifty ads) including a coupon. The fixed number of advertisement notifications would be distributed to users within a specified distance of the restaurant. After all of the fixed number of ads has been distributed, the alert system would cease to distribute the advertisement. If the number of customers in the restaurant has been sufficiently increased by the issued advertisements, the process ends. Alternatively, the owner can elect to purchase additional advertisements, which can be issued almost immediately. The alert system 1100 can effectively create an advertisement that reaches a predetermined number of people, within a defined geographic area. The system may also be able to distribute the advertisements to users who have indicated a predisposition to the products advertised, benefiting both vendors and consumers.

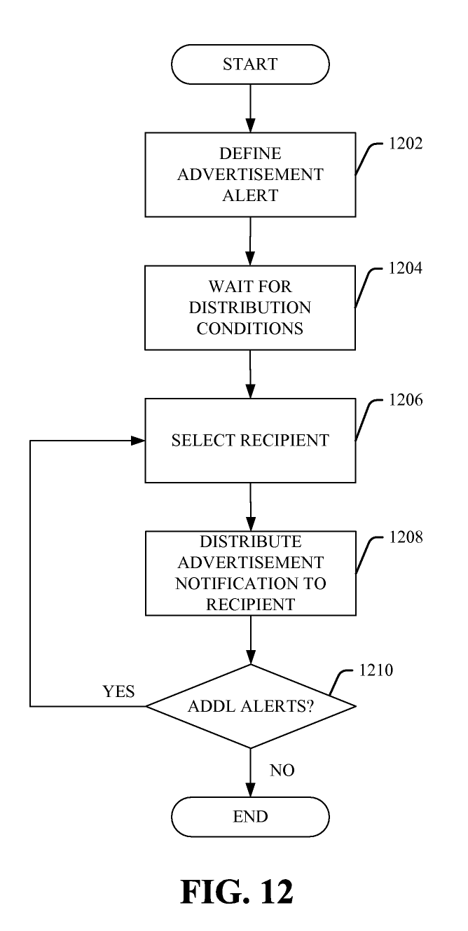

Referring now to FIG. 12, a methodology for creating advertisement alerts and distributing advertisement notifications is illustrated. At reference numeral 1202, an advertisement alert is defined for a specific geographic region. The specification can include an active period of time during which the advertisement is to be distributed and/or a maximum number of advertisement notifications to distribute. The specification can also define the information to be included in the advertisement notification (e.g., text message, coupon and the like) and an alert category (e.g., fast food, electronic equipment, etc.). At reference numeral 1204, the process waits until the active period for the advertisement alert. During the active period, a user is selected within the region specified for the alert at reference numeral 1206. Selected users can be limited to those users that have indicated a willingness to receive advertisements generally, or to receive the particular type or category of the advertisement alert. At reference numeral 1208, the advertisement notification is distributed to the selected user. A determination is made as to whether additional advertisements are to be distributed at 1210. The determination can be based upon the active period of the advertisement alert or based upon the number of notifications already distributed and the maximum number of notifications to be distributed. If additional advertisements are to be distributed, the process returns to reference numeral 1206. If no additional advertisements are to be distributed, the process terminates.

Turning once again to FIG. 11, the alert system 1100 can also include a location prediction component 1104. The location prediction component 1104 can generate an estimate or prediction of user's location at a future point in time based upon the current and past location information retrieved from the device location data store 110. Location prediction is particularly useful when the user is traveling. Information regarding what is ahead of the user on the road (e.g., traffic accidents, coffee shops and fast food) can be more useful than information regarding the user's current location. For example, if a user is on a highway, information regarding historical monuments or vendors located a few miles further along the highway are much more likely to be helpful to a user than information associated with an exit that the user is in the process of passing. Location prediction can also be used in conjunction with advertisement alerts to identify users approaching the vendor's location as opposed to users leaving the area of the vendor's location.

The location of the user can be predicted using a variety of algorithms and techniques. The location prediction component 1104 can determine whether the user is on a highway based upon current location information and determine direction of travel based upon prior location information. The location prediction component 1104 can then estimate the likely location of the user on the highway for a period of time. Alternatively, the location predication component 1104 can include or utilize machine learning, artificial intelligence or inference components, systems, algorithms or mechanisms to predict future location of the user's mobile device. The location prediction component 1104 can utilize past location information to identify patterns and/or common routes. The alert evaluator component 112 can determine if alerts are actuated for the user or other users with alert permission based upon the predicted location of the user, instead of, or in addition to the current location.

The alert system 1100 can also include a landmark data store 1106. The landmark data store 1106 can include landmark or location information in a context that is readily understandable to the user. While latitude and longitude can provide an exact location on the surface of the earth, most users will be unable to utilize latitude and longitude. Even street addresses may not truly give a user an accurate idea of a location. Even if users are familiar with the location of the street, they may be unable to readily identify the portion of the street that contains the relevant address. Typically, users navigate based upon landmarks such as easily identifiable buildings (e.g., the airport), intersections (e.g., a highway interchange) or familiar locations (e.g., home, office or a favorite restaurant).

In addition to, or in combination with the geographic data store illustrated in FIG. 6, the alert system can include the landmark data store 1106. Landmarks can include a set of predefined conspicuous buildings, structures or other objects (e.g., the local airport or a municipal stadium). In addition, users can add and exchange landmarks. An alert can reference a landmark that is closest to the location in addition to providing a street address. A user's personal or custom landmarks can be preferred over system landmarks, in which case a notification can include the closest custom landmark even if a system provided landmark is closer to the desired location.

The aforementioned systems have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Additionally, it should be noted that one or more components may be combined into a single component providing aggregate functionality or divided into several sub-components. The components may also interact with one or more other components not specifically described herein but known by those of skill in the art.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While for purposes of simplicity of explanation, the methodologies that can be implemented in accordance with the disclosed subject matter were shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media.

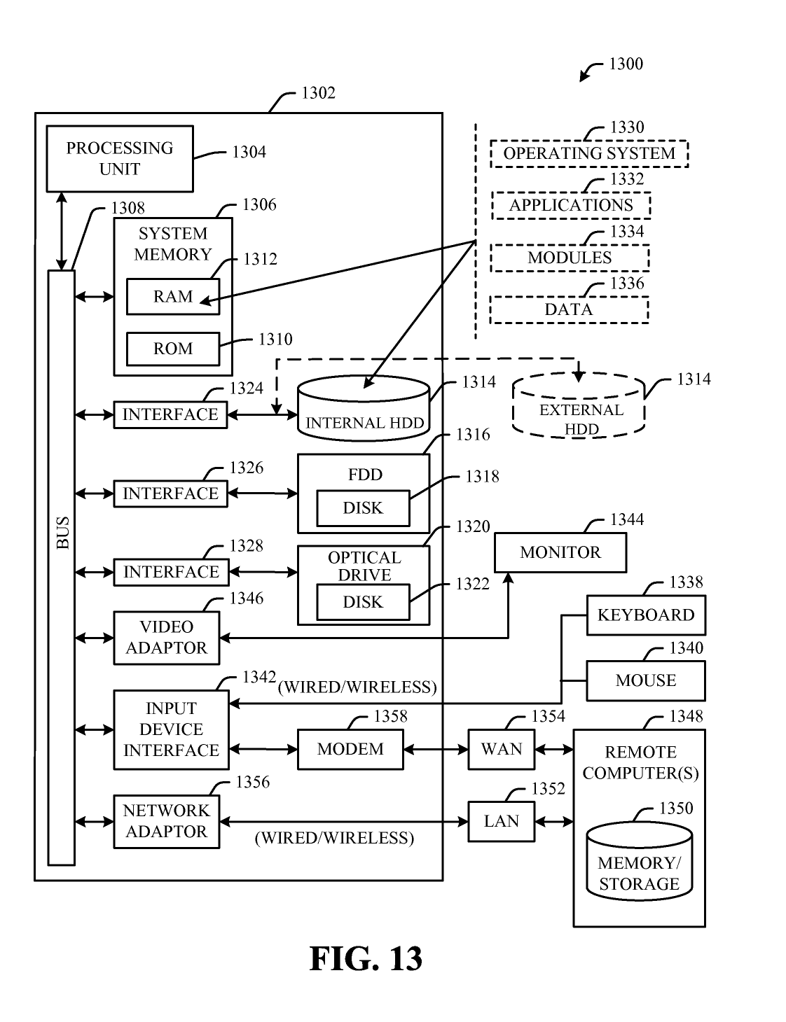

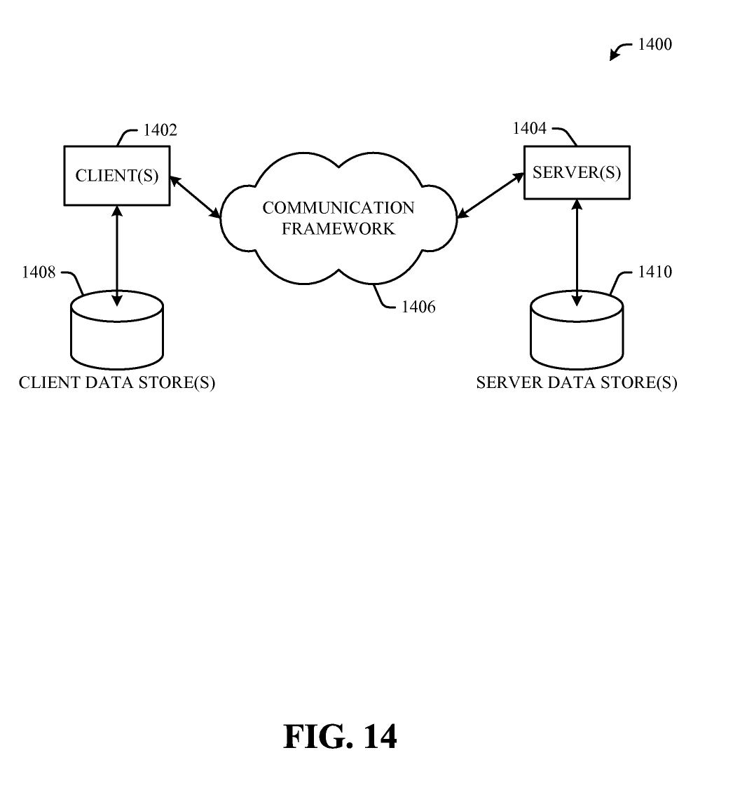

In order to provide a context for the various aspects of the disclosed subject matter, FIGS. 13 and 14 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the system and methods disclosed herein also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the systems and methods described herein can be practiced on stand-alone computers. In a distributed computing environment, program modules may be located in both local and remote memory storage devices.

With reference again to FIG. 13, the exemplary environment 1300 for implementing various aspects of the embodiments includes a mobile device or computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures may also be employed as the processing unit 1304.

The system memory 1306 includes read-only memory (ROM) 1310 and random access memory (RAM) 1312. A basic input/output system (BIOS) is stored in a non-volatile memory 1310 such as ROM, EPROM, EEPROM, which BIOS contains the basic routines that help to transfer information between elements within the computer 1302, such as during start-up. The RAM 1312 can also include a high-speed RAM such as static RAM for caching data.

The computer or mobile device 1302 further includes an internal hard disk drive (HDD) 1314 (e.g., EIDE, SATA), which internal hard disk drive 1314 may also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The hard disk drive 1314, magnetic disk drive 1316 and optical disk drive 1320 can be connected to the system bus 1308 by a hard disk drive interface 1324, a magnetic disk drive interface 1326 and an optical drive interface 1328, respectively. The interface 1324 for external drive implementations includes at least one or both of Universal Serial Bus (USB) and IEEE 1194 interface technologies. Other external drive connection technologies are within contemplation of the subject systems and methods.

The drives and their associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods for the embodiments of the data management system described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. It is appreciated that the systems and methods can be implemented with various commercially available operating systems or combinations of operating systems.

A user can enter commands and information into the computer 1302 through one or more wired/wireless input devices, e.g., a keyboard 1338 and a pointing device, such as a mouse 1340. Other input devices (not shown) may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE 1194 serial port, a game port, a USB port, an IR interface, etc. A display device 1344 can be used to provide a set of group items to a user. The display devices can be connected to the system bus 1308 via an interface, such as a video adapter 1346.

The mobile device or computer 1302 may operate in a networked environment using logical connections via wired and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wired/wireless connectivity to a local area network (LAN) 1352 and/or larger networks, e.g., a wide area network (WAN) 1354. Such LAN and WAN networking environments are commonplace in offices and companies, and facilitate enterprise-wide computer networks, such as intranets, all of which may connect to a global communications network, e.g., the Internet.

When used in a LAN networking environment, the computer 1302 is connected to the local network 1352 through a wired and/or wireless communication network interface or adapter 1356. The adaptor 1356 may facilitate wired or wireless communication to the LAN 1352, which may also include a wireless access point disposed thereon for communicating with the wireless adaptor 1356.

When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wired or wireless device, is connected to the system bus 1308 via the serial port interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with any wireless devices or entities operatively disposed in wireless communication, e.g., a printer, scanner, desktop and/or portable computer, PDA, communications satellite, any piece of equipment or location associated with a wirelessly detectable tag (e.g., a kiosk, news stand, restroom), and telephone. The wireless devices or entities include at least Wi-Fi and Bluetooth™ wireless technologies. Thus, the communication can be a predefined structure as with a conventional network or simply an ad hoc communication between at least two devices.

Wi-Fi allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

FIG. 14 is a schematic block diagram of a sample-computing environment 1400 with which the systems and methods described herein can interact. The system 1400 includes one or more client(s) 1402. The client(s) 1402 can be hardware and/or software (e.g., threads, processes, computing devices). The system 1400 also includes one or more server(s) 1404. Thus, system 1400 can correspond to a two-tier client server model or a multi-tier model (e.g., client, middle tier server, data server), amongst other models. The server(s) 1404 can also be hardware and/or software (e.g., threads, processes, computing devices). One possible communication between a client 1402 and a server 1404 may be in the form of a data packet adapted to be transmitted between two or more computer processes. The system 1400 includes a communication framework 1406 that can be employed to facilitate communications between the client(s) 1402 and the server(s) 1404. The client(s) 1402 are operably connected to one or more client data store(s) 1408 that can be employed to store information local to the client(s) 1402. Similarly, the server(s) 1404 are operably connected to one or more server data store(s) 1410 that can be employed to store information local to the servers 1404.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” are used in either the detailed description or the claims, such terms are intended to be inclusive in a manner similar to the term “comprising” as “comprising” is interpreted when employed as a transitional word in a claim.

What is claimed is:

1. A computer implemented system for providing location based alerts to a user, comprising:
an account interface that manages a user defined alert associated with a user account corresponding to a mobile device;
an alert evaluator component that determines that a condition of the alert has been met based at least in part upon location information; and
a distributor component that distributes a notification to the user as a function of the alert.

2. The system of claim 1, the location information includes location of the user and a defined geographical location, the alert condition is a function of physical proximity of the user to the defined geographical location.

3. The system of claim 1, the location information includes location of the user and location of a second mobile device user, the alert condition is a function of physical proximity of the user and the second mobile device user.

4. The system of claim 1, the location information includes locality of a plurality of mobile device users, the alert condition is a function of physical proximity between at least two of the plurality of mobile device users.

5. The system of claim 1, the location information includes locality of a plurality of mobile device users and a defined geographical location, the alert condition is a function of physical proximity of at least one of the plurality of mobile device users and the defined geographical location.

6. The system of claim 1, the location information includes location for a second mobile device user over a period of time and the alert condition is a function of the distance traveled by the second mobile device user over the period of time.

7. The system of claim 1, the location information includes location of an event and a defined geographical location, the alert condition is a function of physical proximity of the event to the defined geographical location.

8. The system of claim 7, the location of the event is provided by an individual mobile device user.

9. The system of claim 1, the alert condition is based at least in part upon elapsed time since the location information was recorded.

10. The system of claim 1, the location information includes location of a mobile device user and a defined geographical location, the alert condition is based at least in part upon length of time the mobile device user is in proximity of the defined geographical location.

11. The system of claim 1, the location information includes location of a first mobile device user and location of a second mobile device user, the alert condition is a function of length of time the first mobile device user is in physical proximity of the second mobile device user.

12. The system of claim 1, the notification includes actionable data that includes at least one of the location information, a phone number and a uniform resource locator (URL).

13. The system of claim 1, the alert condition is a function of physical proximity to a type of location.

14. A method for providing location-based alerts to a user device, comprising:
defining an advertisement alert specific to a geographic region;
selecting a user device based at least in part upon location of the user device and the geographic region; and
transmitting a notification to the selected user device based at least in part upon the advertisement alert.

15. The method of claim 14, further comprising:
specifying a maximum number of user devices to which the notification is to be transmitted.

16. The method of claim 14, further comprising:
specifying an active period for the advertisement alert, the notification is transmitted during the active period.

17. The method of claim 14, further comprising:
specifying an advertisement category for the advertisement alert, the user device is selected based at least in part upon the advertisement category and an operator of the user device has expressed an interest in the advertisement category.

18. A system for providing location based alerts to a user device, comprising:
means for managing a set of alerts associated with a user account;
means for evaluating the set of alerts; and
means for distributing a notification for an alert of the set of alerts to the user device.

19. The system of claim 18, the set of alerts includes an advertisement alert specific to a geographic region.

20. The system of claim 19, the advertisement alert includes a classification and an operator of the user device has requested the advertisement classification.
